(19) United States
(12) Patent Application Publication
(10) Pub. No.: US 2007/0176006 A1
(43) Pub. Date: Aug. 2, 2007

(54) Apparatus and methods for facilitating multi-component, goal-oriented processes

(76) Inventor: Ann Camille Saunders, Washington, DC (US)

Correspondence Address: CAHN & SAMUELS LLP, 2000 P STREET NW, SUITE 200, WASHINGTON, DC, 20036, US

(21) Appl. No.: 11/488,847

(22) Filed: Jul. 19, 2006

Related U.S. Application Data
(60) Provisional application No. 60/700,341, filed on Jul. 19, 2005.

(51) Int. Cl. G06K 19/00

(52) U.S. Cl. 235/487

(57) ABSTRACT

A deck of cards for facilitating a multi-component, goal-oriented process such as development of a business and methods therefore including a plurality of cards each divided into a plurality of areas, the first area containing a process component, and each card including color-coding corresponding to at least one of several modular categories and either at least one sequential alpha-numeric value or a phrase. As constructed, the cards may be organized individually, modularly, linearly or in combinations thereof.

This application claims the benefit of provisional application Ser. No. 60/700,341 filed Jul. 19, 2005 which is herein incorporated by reference in its entirety.

### I. FIELD OF THE INVENTION

This invention relates to an apparatus for facilitating multi-component, goal-oriented processes (such as development of a business) and methods therefore.

### II. BACKGROUND OF THE INVENTION

Multi-component, goal-oriented processes such as development of a business are commonly “taught” using traditional educational methods and tools, such as books, pamphlets, magazines, audio and video recordings, compact discs or digital video discs. Traditional teaching methods occur in a linear fashion, with one lesson or step following another. Necessary first steps are accomplished before second steps, and so on. While a linear method provides a roadmap toward achievement of a specific goal, the linear method, by itself is limiting. Certain goal-oriented processes, such as developing a new business, are very complex and multi-faceted, and can be broken down into numerous individual, and often overlapping components. The priority and ordering of these components varies according to the prior experience and expertise of the user and the unique requirements of the project. In some cases certain steps must be repeated. In other instances, certain steps are unnecessary and can be disregarded.

Fixed, linear methods of instruction, such as those discussed above, do not readily adapt to dynamic processes involving multiple, changing components. Such processes are better addressed by a plurality of manipulable structures, such as hand-held cards, each representing a single component. A deck of cards, for example, is an efficient way to facilitate such a process. Cards are easy to use—fitting into the hand. They do not require a power source and are easy to store, taking up minimal space. Cards can be individually manipulated; they can be organized, reorganized, reused or, if necessary, disregarded.

Flexibility is optimized if such cards are capable of use in a variety of ways: on an individual basis, clustered into useable groupings, or in linear order. Organization on an individual basis allows the user optimal flexibility; use on a modular basis allows the user, for example, to focus on a particular sub-part of the process; and, as noted above, linear organization is not only valuable, but virtually essential for progression toward a goal. While each of these organizational manners are valuable, a process-facilitation tool reaches its greatest potential if it accommodates more than one of these manners and allows their use in combination. For example, a deck of cards has great utility if it provides a means to organize the cards in a linear fashion even after the cards are modularized or individually clustered by the user.

The fixed methods discussed above, typically achieve modular organization by separating topics into chapters, in a book for example. However, in real-time application, issues such as budgeting or research (in a business development application, for example) are present throughout the entire process. Budgeting issues (of an increasingly detailed nature), for example, arise several times during the process. It would be a rare instance for a business developer to handle every single budgeting issue before moving on to another topic, such as organizational planning. Real life is not that compartmentalized; in practice, these issues are intermingled. Thus, process facilitation is best facilitated by a flexible product or method capable of accommodating real life.

Traditional modular organization of information by chapters, for example, is also limiting in that it allows only a single layer of clustering. In practical application, there can be numerous layers of organization within any given process. For example, a development process might be organized by business topics—budgeting or research. However, at any given time a particular user might want to focus less on particular topics and more on the manner in which he or she is doing the work. For example, the user might want to perform specific physical activities, regardless of the business topic, such as visiting a bank (budget/money) or writing a mission statement (planning). On another day, the same user might want relatively little physical activity in favor of dreaming or brainstorming in response, for example, to focused, probing questions (regardless of the business topic). Traditional methods are not usually capable of being organized on more than a single modular layer and, therefore, do not accommodate a variety of sometimes overlapping modular organizations.

Decks of individual cards, such as flashcards, have traditionally been used for memory-based learning. Typically, a flash card has a question (for example, a math equation) on one side, and the answer on the second side. While the use of flash cards allows random/individual exposure to numerous components, they are not typically organized toward linear achievement of a particular goal. They also are not modularized, as they do not typically integrate several disciplines (math, English, and social studies, for example).

While there are some educational card deck systems directed toward business concepts and issues, these are typically used to encourage memorization (similar to flash cards), and not to facilitate a user through a multi-component, goal-oriented process. Some such card systems provide a means of modular clustering by color-coding, acronyms or printing on the backside of the card, however these are not designed for overlapping modular grouping. Some such systems use acronyms which typically must be short in order to be memorable and are, therefore, limiting in a linear sense. A single scheme of colors and/or printing on the back side of such cards also requires greater manipulation, and has the potential for greater confusion by the user than if the indicia were all on the front.

Notwithstanding the usefulness of devices and methods previously used to facilitate multi-component, goal-oriented processes, a need still exists for a card deck capable of facilitating the process in a flexible and easy manner allowing organization of the components individually, modularly, or linearly or in a combination of these manners.

### III. SUMMARY OF THE INVENTION

In one embodiment of the invention a deck of cards is provided for facilitating a multi-component, goal-oriented process (preferably development of a business). Each card in the deck includes a first area having (i) indicia of a first modular category, (ii) a select process component, (iii) a first color corresponding to the first modular category, and (iv) indicia of a second modular category whereby the select process component corresponds to the second modular category. A a second area includes one of (i) a second color corresponding to the second modular category and (ii) a third color corresponding to said first color. In view of these features, a user can organize the plurality of cards according to one or more of the first modular category and the second modular category.

In accordance with another embodiment method of making a plurality of cards for facilitating a multi-component goal oriented process is provided. The method includes placing a select process component onto each of a plurality of cards where each card is divided into at least a first area and a second area. The process component is located within the first area. The method further includes coloring the first area with a first color corresponding to a select first modular category, coloring said second area with a second color corresponding to a select second modular category and/or a third color corresponding to the first color. The method still further includes placing indicia of a third modular category on the first area of at least one of the plurality of cards.

In the following enabling description, reference is made to the accompanying drawings which are shown by way of illustration of the specific embodiments in which the invention may be practiced. In the following embodiments the apparatus and methods should become evident to a person of ordinary skill in the art and in sufficient detail to enable those skilled in the art to practice the invention. It is to be understood that other embodiments may be used and that structural changes based on presently known structural and/or functional equivalents may be made without departing from the scope of the invention.

### IV. BRIEF DESCRIPTION OF THE DRAWINGS

FIG. 1 is an illustration of an embodiment of the front side of a card according to the invention.

FIG. 2 is an illustration of another embodiment of the front side of a card according to the invention.

FIG. 3 is an illustration of a further embodiment of the front side of a card according to the invention.

FIG. 4 is an illustration of yet another embodiment of the front side of a card according to the invention.

### V. DETAILED DESCRIPTION OF THE INVENTION

As used herein, the phrases “substantially,” “generally,” “relatively” and other words of degree are relative modifiers intended to indicate permissible variation from the characteristic so modified. They are not intended to be limited to the absolute value or characteristic which they modify, but rather possessing more of the physical or functional characteristic than its opposite, and preferably approaching or approximating such a physical or functional characteristic.

As used herein, the phrases “color”, “colored”, “coloring” and “color-coding” refer to any distinctive indicia, including colorization, patterns, printing, shading, graphics, neutrals, blanks or any combination of the same.

As used herein the term card includes playing cards formed from paper or plastic products and digital representations of playing cards generated by computing devices such as PCs, PDAs, DVD players, cell phones, etc.

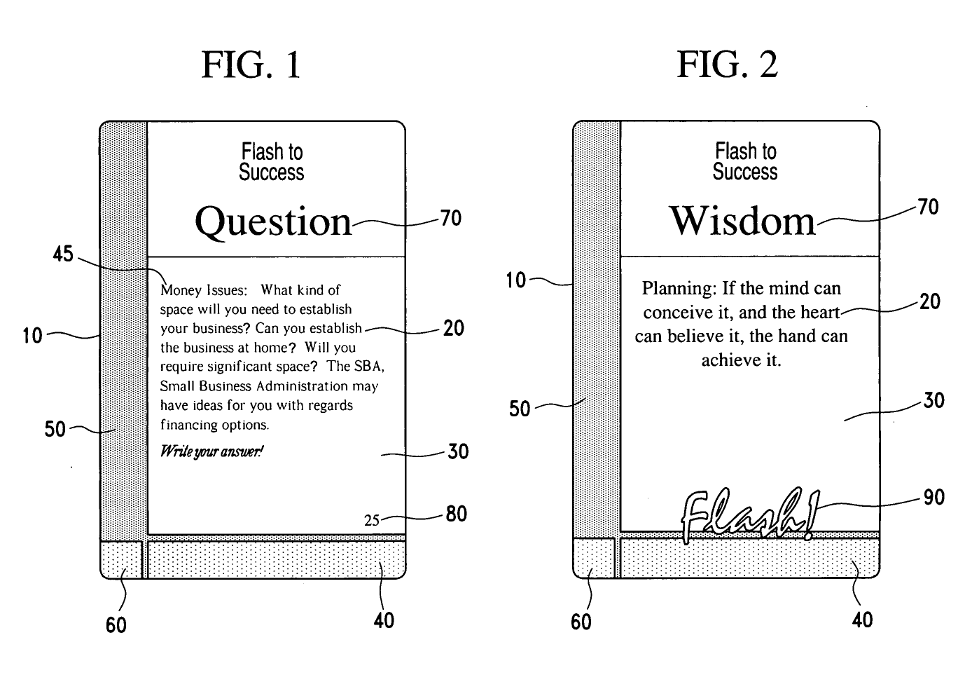

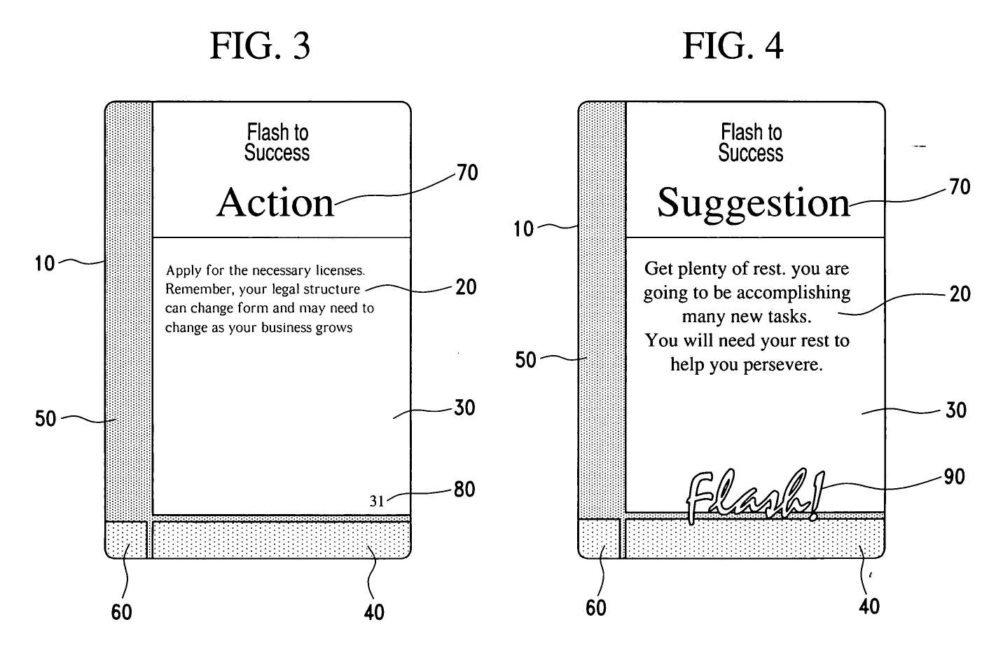

The present invention is generally directed to an apparatus and method for facilitating a multi-component, goal-oriented process. The apparatus may be realized in a variety of media, e.g., a deck of cards or a computer readable medium having program code stored thereon. In accordance with one embodiment of the invention, a deck of cards including a plurality of individual cards 10 is provided. In accordance with one embodiment of the invention illustrated in FIGS. 1 through 4, the front side of each of the plurality of cards 10, contains an individual component of a process for development of a business. Each card 10 contains color-coding associated with at least one category of modular organization, thereby allowing the user to group together a sub-set of cards 10 relating to each such category. Each card 10 also contains either an alpha-numeric value 80 (FIGS. 1 and 3) allowing linear organization, or a phrase such as “FLASH!” 90 (FIGS. 2 and 4).

In the illustrated embodiments, each card 10 is divided into four areas 30, 40, 50, and 60. In an exemplary embodiment of the invention, the first area 30 is larger than any other area. The first area 30 contains a writing 20 which expresses a process component. Because each card 10 contains a different component of the process, the deck can be individually organized or re-organized to fit a particular user's needs. For example, the user can select seven (7) cards 10 to indicate the components to be addressed during each day of a particular week. Alternatively, by way of example, cards 10 can be placed into three (3) piles representing the assignments of three (3) different individuals working on the same process. As the user progresses through the process, he or she can reorganize the cards 10 as needs change. Certain cards 10 can be reused, or cards 10 that are irrelevant to a particular process can also be disregarded. Toward the end of the process, the user can shuffle the deck, then review each card 10 to ensure that all necessary components have been addressed.

In the illustrated embodiments, some of the cards 10 bear an alpha-numeric value 80. For example, the card 10 illustrated in FIG. 1 contains the numeral “25” in the bottom right corner of the first area 30. This is the twenty-fifth (25^{th}) card 10 in a sequence. The card 10 in FIG. 3 bears the numeral “31”, and is the thirty-first (31^{st}) card 10 in the sequence. According to the invention, a card 10 can also bear a letter (“A” through “Z” for example) or a combination of numerals and letters (“16a” “G-17” or “AA” for example), thereby facilitating a variety of linear organizations/groupings. For example, a series of cards 10 numbered “16a”, “16b”, and “16c” might all relate to a particular primary subject represented by the number “16”. This embodiment of a number/letter combination might allow the user to delve more deeply into that subject without disrupting the progression ( . . . 15, 16, 17 . . . ). Numbering the cards 10 allows the user to ensure that all of the necessary components of the process are included. For example, if the user determines that the card numbered “13” is missing, he or she is then made aware that a component of the process is missing.

The use of multiple alpha-numeric values 80 allows multiple overlapping linear progressions. For example, the cards 10 in a single 26-card deck can be organized from “1” to “26” and also, independently, organized from “A” to “Z”. Thus, the card numbered “G-17” might be the seventeenth card in the numeric sequence and the 7^{th} card (“G” being the 7^{th} letter of the alphabet) in the alphabetic sequence.

In the illustrated embodiments, not all of the cards 10 bear an alpha-numeric value 80. For example, in the embodiments illustrated in FIGS. 2 and 4, the cards 10 instead bear the phrase “FLASH!” 90. In these embodiments, the “FLASH!” Cards do not fit within any alpha-numeric sequence. The “FLASH!” Cards can be mixed into the deck or any smaller grouping of cards 10 to randomly interrupt, without disrupting, the linear sequence. This creates an element of randomness and curiosity, making the process more interesting. “FLASH!” Cards can also be separated from the deck and grouped together in a non-linear organization. “FLASH!” Cards might contain a component which facilitates the process regardless of the card's location within the sequence. Alternatively, the “FLASH!” Cards might contain material that, while not necessary to the process, nevertheless adds to and is a component of the facilitation experience.

The first area 30 of each card 10 in the embodiments illustrated in FIGS. 1 to 4 bears a first color and a heading 70 associated with one of four, exemplary categories: Question, Suggestion, Action, and Wisdom. (A first area heading 70 is not contained in all embodiments of the invention.) These categories define a first scheme for modular organization based upon the type of user interaction. The first color and heading 70 of the first area 30 allow the user to organize the cards according to this first modular scheme and to thereby focus on a particular interactive type. For example, if the user wants to take action, he or she can flip through the deck for those cards 10 colored light Green/Yellow and bearing the heading 70 “Action”. The user can remove all such “Action” Cards from the deck, clustering them separately, and then purposefully, randomly, or linearly select a card and its corresponding action component from the cluster. This cluster of “Action” Cards can be organized according to the alpha-numeric values 80 on the cards 10. Although this cluster does not contain every number in the sequence, the “Action” Cards nevertheless can be organized in a linear fashion (lower numbers before higher numbers), thereby allowing the user to execute actions in an orderly linear progression. The same can be done within each of the categories in the first modular scheme (Question, Suggestion, Action, and Wisdom).

In the illustrated embodiments, each card 10 also contains a second area 40 located below the first area 30, along the bottom periphery and toward the bottom-right corner of the front of the card 10. In FIGS. 1 and 2, this second area 40 bears a second color coordinated to a second modular organizational category 45. In these embodiments, the second modular category includes particular business topics such as “Planning” and “Money Issues”. For example, in FIG. 1 the second area is colored Green corresponding to the category “Money Issues”. In this embodiment, the second modular category 45 (“Money Issues”) is identified in the writing 20 disposed in the first area 30. In the embodiment illustrated in FIG. 2, the second area 40 has a second color of Red, corresponding to the second modular category “Planning”. “Planning” is also identified in the writing 20 contained in the first area 30.

According to the invention, the cards 10 do not necessarily reference a second modular scheme. For example FIG. 3 illustrates a card 10 bearing the “Action” heading 70 and first color (light Green/Yellow). The card 10 in FIG. 3, however, does not correspond to any category within the second (business topic) modular scheme. Similarly, FIG. 4 bears the “Suggestion” heading 70 and first color (light Orange), but also does not correspond to any category in the second modular scheme. In the embodiments illustrated in FIGS. 3 and 4, the color of the second area 40 does not correspond to any category in the second modular scheme. Instead the second area bears a third color which coordinates to the color of the first area 30. For example, the second area 40 of the embodiment illustrated in FIG. 3, has a third color of dark Green/Yellow which compliments the light Green/Yellow first color of the first area 30. The second area 40 of the embodiment in FIG. 4 similarly has a third color of dark Orange which compliments the light Orange first color of the first area 30 of the card 10. In some embodiments, the second area 40 and the first area 30 bear different shades of the same basic color.

In the embodiments illustrated in FIGS. 1 and 2, the second modular scheme overlaps the first modular scheme. For example, FIG. 1 illustrates a “Question” Card, which also deals with “Money Issues”. The card 10 in FIG. 2 is a “Question” Card dealing with “Planning” issues. In this way, the user can more specifically focus his or her organization of the process components according to two independent and overlapping modular schemes. For example, a user might remove from the deck all cards 10 relating to both the “Action” interactive type (of the first modular scheme) and the “Management” business topic (of the second modular scheme). These might be ordered randomly, intentionally, or linearly according to their alpha-numeric value 80, as discussed above. The first modular scheme can be used without regard to the second modular scheme or the alpha-numeric ordering, and vice versa. For example, the user can remove all “Planning” Cards from the deck, regardless of whether the cards 10 are “Action” Cards, “Question” Cards, etc. and can organize them randomly or in numeric order. The user can also intentionally or randomly select any set of cards 10 regardless of whether they are “Question” Cards or whether they relate to Money Issues or Management, and can organize them randomly, intentionally, or linearly.

In the illustrated embodiments, each card 10 contains a third area 50 (located along the left periphery and toward the upper-left corner of the card 10) and a fourth area 60 (near the bottom left corner of the card 10). In FIGS. 1 through 4, the third area 50 and the fourth area 60 are not colored to correspond to any modular scheme. In these embodiments, the color of the third area 50 and the fourth area 60 are the same on every card 10, and can be used to identify the cards 10 as belonging to the Business Development deck. Of course, these areas could instead be used for a third or a fourth modular category. Also, the third and/or fourth areas can be used to identify cards 10 belonging to another deck (directed toward another multi-component, goal-oriented process).

The invention also includes methods for facilitating the multi-component, goal-oriented process. According to an embodiment, the method comprises the steps of placing each component of the process onto one of a plurality of cards 10 belonging to a deck. The front of each card 10 is divided into at least a first area 30 and a second area 40, as described above. The first area 30 is larger than any other area and contains the process component (in a writing 20, for example). The method further includes the step of coloring the first area 30 to corresponding to a first modular category and coloring the second area 40 to correspond either to a second modular scheme or to the color of the first area. The method also includes the step of placing either at least one alpha-numeric value 80 and/or a phrase on the front of the card 10. Phrase 90 preferably indicates that card 10 does not follow an alpha-numeric grouping scheme but is what as sometimes referred to as a “wild” card.

While the invention has been described herein in connection with a deck of cards, as mentioned above, the invention may be realized as program code or software stored on a computer readable medium. Such program code causes a computing device to display digital representations of cards that are identical to the playing cards described herein. The user can manipulate the cards with an input device such as a mouse or via a touch screen to achieve any desired organization.

Given the foregoing, it should be apparent that the specifically described embodiments are illustrative and not intended to be limiting. Furthermore, variations and modifications to the invention should now be apparent to a person having ordinary skill in the art. These variations and modifications are intended to fall within the scope and spirit of the invention as defined by the following claims.

I claim:

1. An apparatus for facilitating a multi-component, goal-oriented process comprising:
a plurality of cards, each card having:
a first area including indicia of a first modular category, a select process component, a first color corresponding to the first modular category, and indicia of a second modular category, the select process component corresponding to the second modular category;
a second area including one of (i) a second color corresponding to the second modular category and (ii) a third color corresponding to said first color;
wherein a user can organize the plurality of cards according to one or more of the first modular category and the second modular category.

2. The apparatus of claim 1 further comprising indicia of a third modular category disposed in said first area.

3. The apparatus claim 2 wherein the indicia is an alpha-numeric value.

4. The apparatus of claim 2 wherein the indicia is a phrase.

5. The apparatus of claim 1 wherein said multi-component, goal-oriented process is development of a business.

6. The apparatus of claim 1 wherein said second area of each card is adjacent a bottom edg.

7. The apparatus of claim 1 wherein said first modular category includes one or more of questions, suggestions, actions, and words of wisdom.

8. The apparatus of claim 1 wherein the indicia of the first modular category includes a heading corresponding to said first modular category.

9. The apparatus of claim 1 wherein said second modular category includes one or more of research, management, money issues, marketing, and planning.

10. The apparatus of claim 1 wherein said process component includes a writing.

11. The apparatus of claim 10 wherein said writing identifies said second modular category.

12. A method of making a plurality of cards for facilitating a multi-component goal oriented process comprising:
placing a select process component onto each of a plurality of cards wherein each card is divided into at least a first area and a second area, and said process component being located within said first area;
coloring said first area with a first color corresponding to a select first modular category,
coloring said second area with one or more of a second color corresponding to a select second modular category, and a third color corresponding to said first color; and
placing indicia of a third modular category on the first area of at least one of the plurality of cards.

13. The method of claim 12 wherein placing the indicia on the card includes placing an alpha-numeric value on at least one of the plurality of cards.

14. The method of claim 13 wherein placing indicia on the card includes placing a phrase on at least one of the plurality of cards that does not include an alpha-numeric value.
